(19) United States
(12) Patent Application Publication
(10) Pub. No.: US 2026/0252728 A1
(43) Pub. Date: Aug. 27, 2026

(54) SPLIT-AGGREGATE FORM STORAGE METHOD AND SYSTEM

(71) Applicant: Kyocera Document Solutions Inc., Osaka (JP)

(72) Inventor: Selim ZAMAN, San Mateo, CA (US)

(73) Assignee: Kyocera Document Solutions Inc., Osaka (JP)

(21) Appl. No.: 19/060,929

(22) Filed: Feb. 24, 2025

(51) Int. Cl. G06F 21/62; G06F 21/60; G06F 40/186; G06V 30/414

(52) U.S. Cl. CPC G06F 21/6245; G06F 21/602; G06F 40/186; G06V 30/414

(57) ABSTRACT

A document management system uploads documents and stores them. The documents include customer-filled forms having a form template and fields within each form having variable data. The data within the fields is extracted and stored in a database. The data can be plain text, confidential text, a signature, or an image. The data for the confidential text and the signature is encrypted prior to storage. The extracted data is placed in a customer form data file that is stored with other data files for the plurality of filled forms along with the form template. The form template and data file is retrieved to regenerate the form with the data within the fields.

### FIELD OF THE INVENTION

The present invention relates to the storage of forms in a database using a split-aggregate process to optimize memory usage.

### DESCRIPTION OF THE RELATED ART

Cloud document management systems may be used to process and store forms completed by end users. Memory space is required to store the forms, even though the differences between one form and another may be limited to the variable fields completed by the user. Memory requirements to store the forms increase proportionally to the number of forms stored. For a large number of forms, the memory requirements for storage may not be feasible.

### SUMMARY OF THE INVENTION

A method for storing data from an image of a form is disclosed. The method includes uploading the image of the form. The method also includes determining a form template corresponding to the form. The method also includes recognizing at least one field type in the image. The method also includes extracting data within the at least one field type. The method also includes storing the data in a database according to the at least one field type. The form template and the stored data corresponds to the image of the form.

In additional embodiments, the feature of recognizing the at least one field type in the image also includes determining when the at least one field type is confidential. It also includes encrypting the extracted data.

In additional embodiments, the method also includes detecting handwritten data. The method also includes converting the handwritten data to text or storing the handwritten data as the image. In some embodiments, the method also includes detecting image data. The method also includes determining when the image data for the at least one field type is confidential. The method also includes storing the image. In some embodiments, the image data is selected from a group that includes signatures and fingerprints.

In additional embodiments, the method also includes generating a corresponding image from the stored data by retrieving the form template corresponding to the image. The method also includes, for each field type in the form template, retrieving the stored data. The method also includes merging the retrieved data into the form template.

In additional embodiments, the method also includes detecting when a field in the form is incomplete. The method also includes comparing data in completed fields to the stored data. The method also includes storing a data object when the field is different than the stored data. The method also includes flagging the image as an incomplete form. In additional embodiments, the method also includes generating a corresponding image from the stored data.

A database for storing data from an image of a form is disclosed. The database includes a form template corresponding to the form. The database also includes data stored according to at least one field type. The database also includes a look-up table including a form identifier, the form template, and the data. The image of the form is reproduced from the form template and the stored data.

In additional embodiments, the at least one field type is chosen from a group consisting of text, signature, confidential, and image. In additional embodiments, when the at least one field type is a signature, the data is stored as an encrypted file. In additional embodiments, when the at least one field type is text, the data is stored as an unencrypted file. In additional embodiments, when the at least one field type is confidential, the data is stored as an encrypted file.

In some embodiments, the form identifier uniquely identifies the image. In some embodiments, the data includes an upload date. In some embodiments, the image of the form includes empty fields.

A system for storing data from an image of a form is disclosed. The system includes a form template corresponding to the form. The system also includes data stored according to at least one field type. The system also includes a look-up table including a form identifier, the form template, and the data. The system also includes a file merger coupled to the form template, the stored data, and the look-up table, operative to reproduce the image of the form.

In additional embodiments, the at least one field type is chosen from a group consisting of text, a signature, confidential, and image. In additional embodiments, the stored data is encrypted and unencrypted. In some embodiments, the file merger is operative to detect when the stored data is encrypted and to generate a corresponding unencrypted version for the image of the form.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, numerous variations are possible. For instance, structural elements and process steps may be rearranged, combined, distributed, eliminated, or otherwise changed, while remaining with the scope of the disclosed embodiments.

### BRIEF DESCRIPTION OF THE DRAWINGS

Various other features and attendant advantages of the present invention will be more fully appreciated when considered in conjunction with the accompanying drawings.

FIG. 1 illustrates a block diagram of a document management system according to the disclosed embodiments.

FIG. 2 illustrates an optical character recognition (OCR) device according to the disclosed embodiments.

FIG. 3 illustrates a block diagram of a system for implementing split-aggregate form storage according to the disclosed embodiments.

FIG. 4 illustrates a block diagram of an uploaded form and its associated stored data according to the disclosed embodiments.

FIG. 5 illustrates a block diagram of retrieving the form within the document management system according to the disclosed embodiments.

FIG. 6 illustrates a flow diagram for implementing a split-aggregate process in storing forms within the document management system according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

The disclosed embodiments provide embodiments whereby the variable fields in the form are extracted and stored in a single file separated by a form identifier based on source information. The form template is stored only once. The result is a reduction in storage space required, from about 80% reduction to 99%, as the number of forms increase. Further, the disclosed embodiments include processing of handwritten fields, signatures, and confidential configuration information through encryption. Thus, a form containing handwritten text, signatures, and any confidential fields are stored in memory in an optimized manner to provide reduced cost of operations and energy consumption paired with sustainable computing.

The disclosed embodiments store the form template as a master document. A text file template is created for storing user provided text, with separation markers for each form. A signature file template is created for storing signatures, with separation markers for each form. For each completed form, the disclosed embodiments extract the input text fields into the text file and append to it as new completed forms are uploaded. In the form template, any secure text fields are marked with private or confidential information for encryption before storing.

For each completed form, the disclosed embodiments extract any confidential fields into an encrypted confidential text file and append to it as new completed forms are uploaded. For each completed form, the disclosed embodiments extract the signature fields into an encrypted signature file and append to it as new completed forms are uploaded. Each form content is separated by a preamble header containing form identification information.

The disclosed embodiments store the four items of master form template, the text file segmented per completed form, the confidential text file per completed form, and the signature file segmented per completed form in a database or storage. The storage may be a cloud-based storage. When retrieving the form for viewing or editing, the disclosed embodiments re-populate the form template with respective text and signature data identified with the header information. Thus, the disclosed embodiments split and aggregate forms to optimize memory usage. The disclosed embodiments also provide storage cost optimization and lower data center energy consumption by separating user-filled contents from the form template.

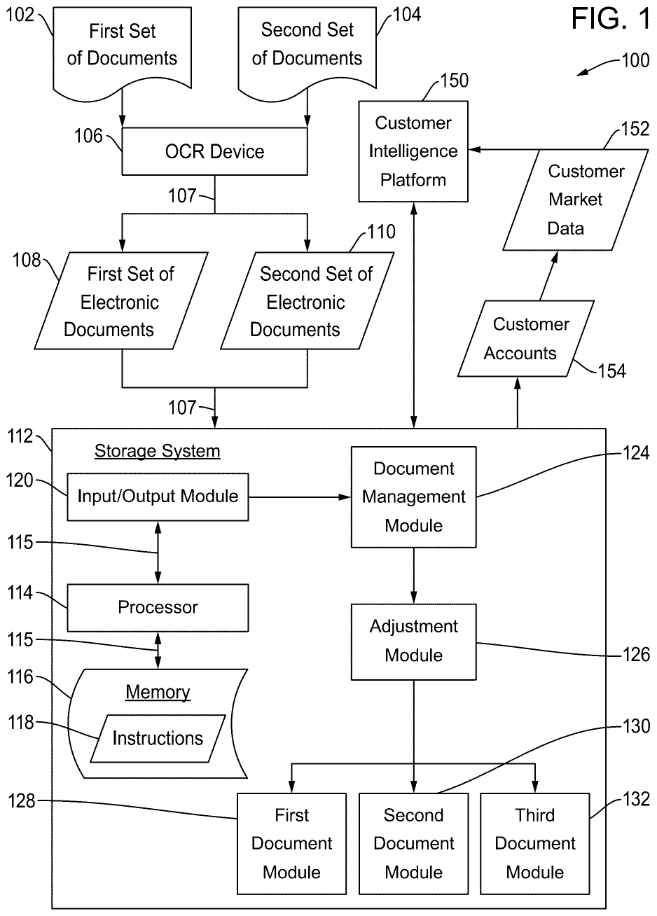

FIG. 1 depicts a block diagram of a document management system 100 according to the disclosed embodiments. Document management system 100 may receive large batches of documents, process them, and manage their access and use in operations. As part of this, document management system 100 uses storage system 112 that stores documents which have been received and processed within system 100. One feature of the processing may be scanning or importing batches of documents by optical character recognition (OCR) device 106.

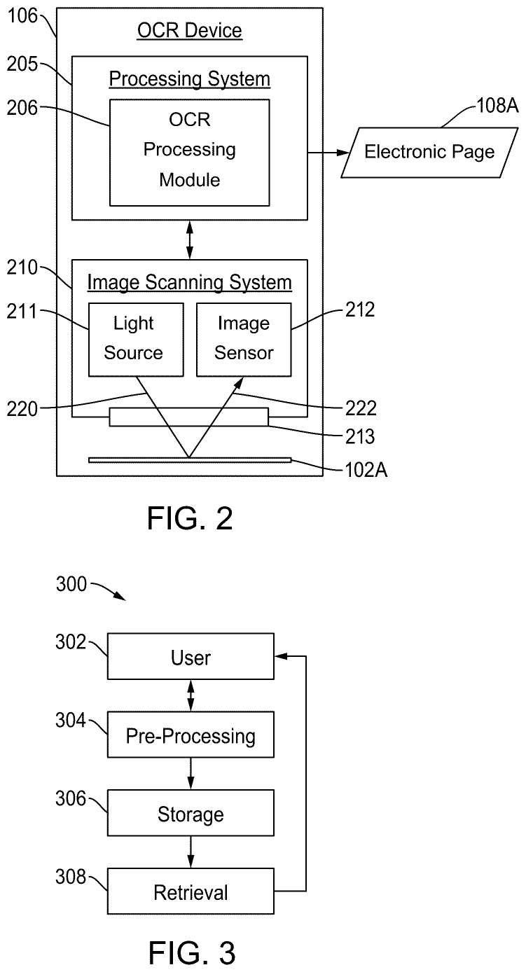

OCR device 106 is communicatively coupled to storage system 112 within system 100. OCR device 106 may be connected to storage system 112 over a network 107. OCR device 106 may be within a printing device, a scanner, a computing device, and the like. OCR device 106 is disclosed in greater detail below by FIG. 2. Within system 100, OCR device 106 helps with the importation of large batches of documents, such as records, books/texts, forms, or other data that is in a document that is captured electronically to be managed using storage system 112.

For example, a first set of documents 102 may be medical records dating back to 1984. Many of these records are on paper and in different formats. OCR device 106 captures images of the records to generate a first set of electronic documents 108. First set of electronic documents 108 are the electronic or image versions of first set of documents 102. First set of electronic documents 108 may be images having pixels to represent the characters and graphics within first set of documents 102. OCR device 106 imports first set of documents 102 into system 100 by processing them.

Using the above example, a second set of documents 104 also may be imported into system 100 using OCR device 106. Second set of documents 104 may be company records kept on paper for the past several years. These records also may include different formats and even different languages. OCR device 106 captures second set of documents 104 to generate a second set of electronic documents 110. Second set of electronic documents 110 also may be images having pixels that represent the characters and graphics within second set of documents 104.

First set of documents 102 is provided to storage system 112. Storage system 112 performs pre-processing of the documents before storing them within a document module. Storage system 112, however, includes a processor 114 that executes instructions to configure the storage system to perform specified functions. Processor 104 is connected to memory storage 116 by data bus 115. Memory storage 116 includes instructions 118. Instructions 118 may be code that, when read by processor 114, configures storage system 112 to perform the operations disclosed herein.

Processor 114 also may be coupled to input/output module 120 for storage system 112. Electronic documents may be imported from OCR device 106 at input/output module 120 over network 104. In some embodiments, storage system 112 and OCR device 106 may be in the same device such that network 107 and input/output module 120 are not used. Upon receipt of the electronic documents, processor 114 executes instructions 118 to configure storage system 112 to perform document management operations.

These operations may include processing a set of electronic documents, such as first set of electronic documents 108, using a document management module 124. Document management module 124 may receive documents within storage system 112 and determine how to handle them. For example, various criteria may be provided to document management module 124 to sort or classify the incoming documents. Example of the criteria may be project, author, unique identification number, company, date, size, and the like. Document management module 124 may assign each document to one of a plurality of document modules within storage system 112.

Adjustment module 126 may adjust documents classified by document management module 124. Different fields, such as dates, may be adjusted. In some embodiments, other criteria may be defined to prompt the adjustment of the original electronic document received at storage system 112. For example, personal information may be redacted from documents before being stored in a document module.

Both sets of electronic documents are stored within storage system 112. Thus, first set of electronic documents 108, as well as any modified electronic versions of the documents, are stored at a document module, or storage. Storage system 112 may include first document module 128, second document module 130, and third document module 132. First document module 128 may store the processed and modified versions of first set of electronic documents 108. Second document module 130 may store the processed and modified versions of second set electronic documents 110. Third document module 132 may include the original versions of the electronic documents only. Each document module may include its own rules and management functions for the corresponding documents.

Document management system 100 also includes customer intelligence platform 150. Customer intelligence platform 150 also may be known as a customer service intelligence platform. Customer intelligence platform 150 may perform customer relationship management within system 100. Customer intelligence platform 150 collects customer market data 152 from various customer accounts 154 within system 100. Customers having customer accounts 154 interact within system 100, such as interacting with storage system 112 to retrieve documents from one of the storage modules. Customers also upload documents using OCR device 106. All of these actions result in customer market data 152.

Customer market data 152 may be data and actions tracked for a specific customer account of customer accounts 154. For example, as customers use system 100 and purchase service or products within system 100, customer intelligence platform 150 may track this information. Customer market data 152 may be provided real-time to platform 150, or may be provided to the platform using periodic updates. Customer accounts 154 may keep track of actions and purchases, then provide this information to customer intelligence platform 150. In some embodiments, customer market data 152 includes customer characteristics, an engagement status, and one or more usage patterns for each customer account. These features are disclosed in greater detail below.

FIG. 2 depicts OCR device 106 according to the disclosed embodiments. OCR device 106 receives a page or document 102A of first set of documents 102. Further pages may be loaded after processing of page 102A is complete. OCR device 106 includes an image scanning system 210 communicatively coupled to a processing system 205 via a communications link 207. Communications link 207 may be a wire, a communications cable, a wireless link, or a metal track on a printed circuit board.

Image scanning system 210 includes a light source 211 that projects light 220 through a transparent window 213 to strike a surface of page 102A. Page 102A, which may be a sheet of paper containing text or graphics, reflects light 220 towards an image sensor 212. Image sensor 212 contains light sensing elements, such as photodiodes or photocells, converts received light 222 into electrical signals that are transmitted to OCR processing module 206 within processing system 205. The electrical signals may be digital bits.

Processing system 205 generates electronic page 108A from the captured data for page 102A. Electronic page 108A is included in one of the electronic documents within first set of electronic documents 108. In some embodiments, OCR device 106 is a slot scanner incorporating a linear array of photocells. OCR processing module 206 that is a part of processing system 205 may be used to operate upon the electrical signals for performing optical character recognition of text and graphics printed on page 102A.

FIG. 3 depicts a block diagram of a system 300 for implementing split-aggregate form storage according to the disclosed embodiments. System 300 may be hosted within storage system 112 of document management system 100. Alternatively, system 300 may be implemented on a device connected to storage system 112. The features of system 300 may be implemented using process 114 and memory 116. Instructions 118 may be executed on one or more processors 114 to enable the functionality provided by system 300.

User component 302 of system 300 may relate to a user. A user may be the form template owner in document management system 100. User component 302 also may interact with a customer. A customer may be the person who submits completed forms within document management system 100. User component 302 may receive completed forms uploaded to document management system 100, as disclosed above. User component 302 also identifies forms filed by customers from the completed forms. User component 302 also may receive a request to view a customer form stored within document management system 100 or storage system 112. User component 302 also may allow the user to view a retrieved form that includes the information related to the form for a specific customer.

User component 302 may interact with pre-processing component 304. Pre-processing component 304 may receive the forms filled by customers to determine whether any hand-written data exists on a specific filled form. If so, then pre-processing component 304 may convert the hand-written data into text. Pre-processing component 304 also extracts variable text fields as filled by a customer. Fields in the forms may include plain data or confidential data. For “plain” data, pre-processing component 304 takes the plain text data from the form. For confidential data or text, pre-processing component 304 encrypts the confidential text or signatures for those fields to generate encrypted data.

Storage component 306 receives the plain text data and the encrypted confidential data from pre-processing component 304 and stores the data in a database. The database may be in storage system 112, such as first document module 128, second document module 130, or third document module 132. The database may store the form template used for the forms uploaded to document management system 100 as well as the plain text and encrypted data for each customer-filled form of the form template.

Retrieval component 308 retrieves the stored data for a customer, such as the variable data of plain text and encrypted data, along with the form template from the database. Retrieval component 308 may decrypt any data as needed. Retrieval component 308 merges the customer data with the applicable form template to recreate the customer-filled form with the information as originally provided. This recreated document may be provided to user component 302 for viewing within document management system 100.

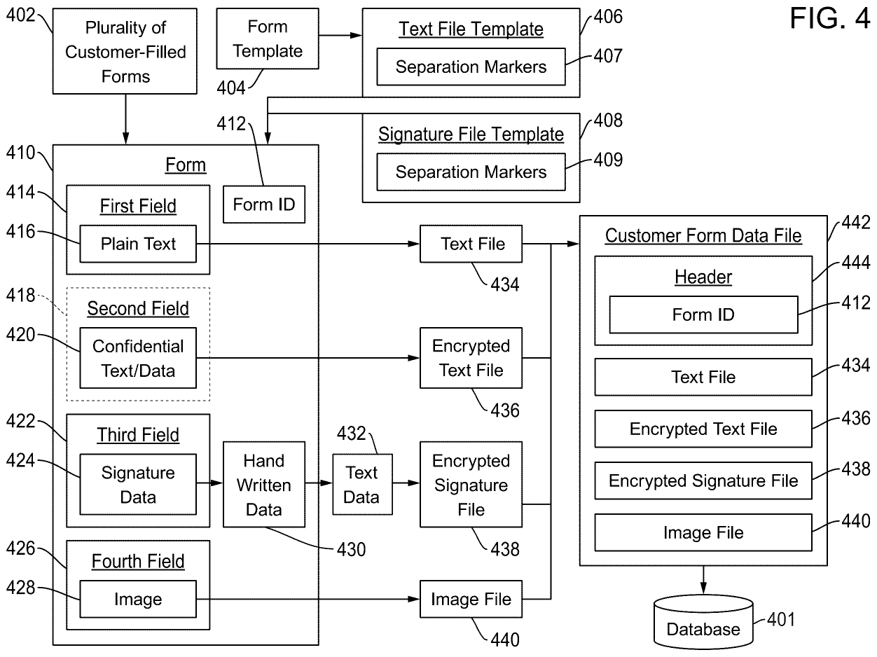

FIG. 4 depicts a block diagram of an uploaded form 410 and its associated stored data according to the disclosed embodiments. Form 410 may be one of a plurality of customer-filled forms 402 uploaded within document management system 100. Forms 402 may be uploaded with first set of documents 102 or second set of documents 104. Each of the forms 402 is associated with form template 404. For example, form 410 is form template 404 filled out with data and information about a specific customer or instance. Multiple customers may fill out the forms, which are then uploaded to be stored.

The following operations may occur at storage system 112 of document management system 100 but also may occur on another device configured to process forms 402 and prepare data from the forms to be stored. The disclosed embodiments may store form template 404 as a master document for use with forms 402. The disclosed embodiments also may create a text file template 406 and signature file template 408 from form template 404. Text file template 406 may be used for storing user provided text in forms 402. It may include separation markers 407 for each form. Signature file template 408 may be used for storing signatures within forms 402. It also may include separation markers 409.

Separation markers 407 and 409 may indicate where text, signatures, and other items of interest are located within form template 404. For example, a separation marker may indicate the location of a field that will have text, a signature, an image, and the like to be analyzed by storage system 112 prior to saving the file for a completed form 410. Form template 404 may include first field 414, second field 418, third field 422, and fourth field 426 that are located in different positions within forms 402. The separation markers indicate where fields 414-426 are within each form.

Form template 404 also should indicate any secure text fields with private or confidential information. Some types of data may not be available for public viewing when form 410 is recreated as disclosed below. This data may include names, identification or social security numbers, addresses, phone or mobile device numbers, IP addresses, and the like. The disclosed embodiments will treat this information differently than regular text data within the forms, such as encrypting the data before storage.

Form 410 may pertain to a specific customer or instance within forms 402. Form 410 may include a form identification 412, which may be a unique identification for that customer or instance. Each form may have a unique identification. Form identification 412 helps track form 410 within storage system 112. Form 410 also includes first field 414, second field 418, third field 422, and fourth field 426 as set forth in form template 404. Each field may have data that is to be extracted from form 410 and stored within storage system 112 along with the data extracted from forms 402.

First field 414 may correspond to a field having plain text 416 as data. Plain text 416 may be one or more words or sets of data placed together in form 410. Plain text 416 should not be private or confidential, or a signature. Plain text 416 is extracted from first field 414 and placed in text file 434. More than one field may have plain text 416 within form 410. Further, form 410 may include text that is not within first field 414 so that it is not stored with text file 434. Such text may be boilerplate or generic data applicable to all forms 402.

Second field 418 may correspond to a field having confidential text or data 420. Confidential text 420 also may be known as private data. As disclosed above, form template 404 may have second field 418 marked as private or confidential. The disclosed embodiments extract confidential text 420 and encrypts this data. The data may be encrypted using known processes, including an encryption key that is provided to an administrator of forms 402. Encrypted confidential text 420 is stored in encrypted text file 436 for form 410.

Third field 422 may correspond to a field having signature data 424. Signature data 424 also may include fingerprint data. Signature data 424, whether a signature or a fingerprint, may be captured as an image within form 410. Signature data 424 may not be “text” data as it may be handwritten. The disclosed embodiments may convert the handwritten signatures into text. Thus, the disclosed embodiments may extract handwritten data 430 as signature data 424 from third field 422 and convert the handwritten data into text data 432. Alternatively, the disclosed embodiments may store the handwritten data as an image and date field without conversion. Signature data 424 that is not handwritten may be stored as text data. Signature data 424 is then encrypted, no matter the format and placed within encrypted signature file 438.

Fourth field 426 corresponds to an image 428 within form 410. For example, fourth field 426 may include a photograph of the customer preparing form 410. Instead of text data, image 428 also may be captured in form 410 and extracted by the disclosed embodiments for storage in image file 440 with the other data for the form that varies between forms 402. Image 428 also may be marked private or confidential. If so, then image 428 also may be encrypted before being placed within image file 440.

The extracted data from form 410 may be compiled into customer form data file 442 having form content. Customer form data file 442 includes a header, or preamble, 444 having form identification 412 to identify form 410 of forms 402. Customer form data file 442 may be unique to form 410. The file includes the extracted data from form 410, including text file 434, encrypted text file 436, encrypted signature file 438, and image file 440. As may be appreciated, customer form data file 442 may include additional data files and information extracted from form 410.

Each form 402 is analyzed and processed like form 410 so that a different customer form data file 442 is generated for each instance. All of the customer form data files for each customer is stored with form template 404 in database 401. Database 401 may be a database within storage system 112 or accessible by storage system 112 in document management system 100. Thus, the amount of storage needed for forms 402 is reduced as each entire form does not need to be stored, but only form template 404 and the extracted data from the designated fields.

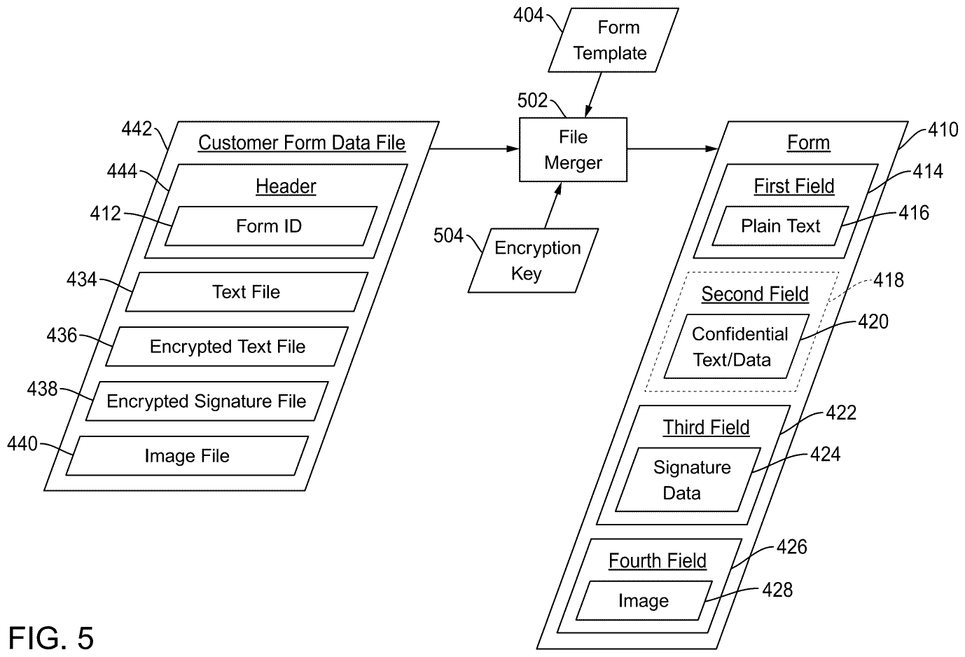

FIG. 5 depicts a block diagram of retrieving form 410 within document management system 100 according to the disclosed embodiments. The disclosed embodiments may receive a request to generate a stored document from the uploaded documents, or plurality of customer-filled forms 402. The request likely refers to one form to be regenerated, or possibly several forms, but not every form of forms 402. The disclosed embodiments retrieve form template 404 and the appropriate customer form data file to recreate the requested form.

In some embodiments, a file merger 502 may be used by storage system 112 or document management system 100 to retrieve the appropriate files and recreate the requested form. For example, a request may be received to regenerate form 410. File merger 502 retrieves form template 404 associated with form identification 412. File merger 502 also retrieves customer form data file 442 of form identification 412.

As disclosed above, customer form data file 442 includes the data and images extracted from form 410 having form identification 412. Customer form data file 442 may not include the entire form 410 but only the data and images identified in its fields as being information that is variable within form 410. Thus, customer form data file 442 includes text file 434, encrypted text file 436, encrypted signature file 438, and image file 440.

File merger 502 receives form template 404 and customer form data file 442 and converts the data within files 434-438 back to the original data. Thus, file merger 502 may use text file 434 to populate first field 414 with plain text 416. File merger 502 may use encrypted text file 436 to populate second field 418 with confidential text 420. In some embodiments, file merger 502 may use an encryption key 504 used to encrypt confidential text 420 to decrypt encrypted text file 426. Other encryption/decryption operations may be used.

File merger 502 also may use encrypted signature file 438 to populate third field 422 with signature data 424. In some embodiments, file merger 502 may use encryption key 504 to encrypt signature data 424 and decrypt encrypted signature file 438 back to signature data. In some instances, signature data 424 may be in image of a captured handwritten signature. File merger 520 may use image file 440 to populate fourth field 426 with image 428.

File merger 502 also may use text file template 406 and signature file template 408 stored along with form template 404 to position the fields properly in form 410. Additional fields may be within form 410. Data from these additional fields may be within the appropriate file in customer form data file 442. The different fields may include indicators, or reference data, along with the extracted data as specified for form template 404. Thus, form 410 is re-populated with the stored data.

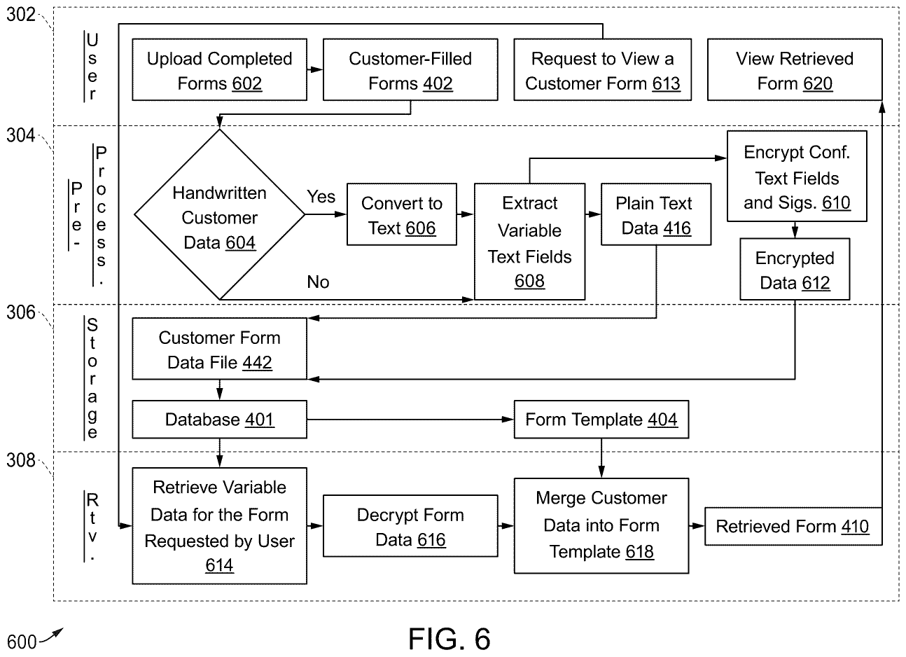

FIG. 6 depicts a flow diagram 600 for implementing a split-aggregate process in storing forms 402 within document management system 100 according to the disclosed embodiments. Flow diagram 600 may refer to FIGS. 1-5 for illustrative purposes. Flow diagram 600, however, is not limited to the embodiments disclosed by FIGS. 1-5.

Flow diagram 600 includes user component 302, pre-processing component 304, storage component 306, and retrieval component 308. User component 302 may include steps 602, 613, and 620, disclosed in greater detail below. Pre-processing component 304 may include steps 604, 606, 608, 610, and 612 disclosed in greater detail below. Storage component 306 may include steps for storing data as disclosed below. Retrieval component 308 may include steps 614, 616, and 618 disclosed in greater detail below.

Step 602 executes by uploading complete forms into document management system 100. For example, plurality of customer-filled forms 402 are uploaded to document management system 100 to be stored within storage system 112. The uploaded documents result in forms 402. Flow diagram 600 proceeds to step 604, which executes by determining whether forms 402 include any handwritten customer data, such as signatures or fingerprints. Handwritten customer data may not be in a text format, but like an image within each form.

If step 604 is yes, then step 606 executes by converting the handwritten customer data into text. This step may be optional in that the handwritten customer data may not be converted. If step 604 is no, then flow diagram 600 proceeds to step 608, which also follows step 606. Step 608 executes by extracting variable text fields within a form, such as form 410, that are filled by the customers. For example, form 410 may include first field 414, second field 418, third field 422, and fourth field 426. Each field has its own unique data, as disclosed above.

Step 608 may extract two types of data. The disclosed embodiments may extract plain text 416, or plain text data. Plain text data does not need to be encrypted. Step 608 also may extract confidential text or signatures. Step 610 executes by encrypting the confidential text data and signatures, such as confidential text 420 and signature data 424 to generate encrypted data 612. Encrypted data 612 may correspond to encrypted text file 436 and encrypted signature file 438. Step 608 also may extract an image within a field of form 410.

Plain text data 416 and encrypted data 612 may be placed together to form customer form data file 442, which is the plain text and encrypted data filled by customers in the specific form. Storage component 306 includes a process to store this data along with form template 404 in database 401.

Referring back to user component 302, step 613 executes by receiving a request to view a customer form, such as form 410. Flow diagram 600 proceeds to step 614 of retrieval component 308, which executes by retrieving the variable data for the form requested by the user from database 401. This data includes the plain text and encrypted data as indicated by form identification 412.

Step 616 executes by decrypting the encrypted data retrieved from database 401. Step 618 executes by merging the decrypted confidential and signature data and the plain text data with form template 404. File merger 502 may be used in this step to recreate form 410 using its original data positioned appropriate in form template 404. Retrieved form 410 may then be forwarded to a user interface. Step 620 executes by viewing retrieved form 410 with its original variable data within the corresponding fields.

In some embodiments, the encrypted data may not be decrypted such that private or confidential information remains hidden. The user may need to provide credentials or something to indicate that the user has the authority to view the encrypted data. Thus, the disclosed embodiments also provide a level of security with regards to the stored data of the filled forms.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A method for storing data from an image of a form, the method comprising:
uploading the image of the form;
determining a form template corresponding to the form;
recognizing at least one field type in the image;
extracting data within the at least one field type; and
storing the data in a database according to the at least one field type,
wherein the form template and the stored data corresponds to the image of the form.

2. The method of claim 1, wherein recognizing the at least one field type in the image further includes:
determining when the at least one field type is confidential; and
encrypting the extracted data.

3. The method of claim 1, comprising:
detecting handwritten data; and
converting the handwritten data to text or storing the handwritten data with the stored data.

4. The method of claim 3, comprising:
detecting image data;
determining when the image data for the at least one field type is confidential; and
storing the image.

5. The method of claim 4, wherein the image data is selected from a group that includes signatures and fingerprints.

6. The method of claim 4, further comprising generating a corresponding image from the stored data by
retrieving the form template corresponding to the image;
for each field type in the form template, retrieving the stored data; and
merging the retrieved data into the form template.

7. The method of claim 1, further comprising:
detecting when a field in the form is incomplete;
comparing data in completed fields to the stored data;
storing a data object when it is different than the stored data; and
flagging the image as an incomplete form.

8. The method of claim 1 further comprising generating a corresponding image from the stored data.

9. A database for storing data from an image of a form, the database comprising:
a form template corresponding to the form;
data stored according to at least one field type in the image; and
a look-up table including a form identifier, the form template, and the data,
wherein the image of the form is reproduced from the form template and the stored data.

10. The database of claim 9, wherein the at least one field type is chosen from a group consisting of text, signature, confidential, and image.

11. The database of claim 9, wherein, when the at least one field type is a signature, the data is stored as an encrypted file.

12. The database of claim 9, wherein, when the at least one field type is text, the data is stored as an unencrypted file.

13. The database of claim 9, wherein, when the field type is confidential, the data is stored as an encrypted file.

14. The database of claim 9, wherein the form identifier uniquely identifies the image.

15. The database of claim 13, wherein the data includes an upload date.

16. The database of claim 14, wherein the image of the form includes an empty field.

17. A system for storing data from an image of a form, the system comprising:
a form template corresponding to the form;
data stored according to at least one field type;
a look-up table including a form identifier, the form template, and the data; and
a file merger coupled to the form template, the stored data, and the look-up table, operative to reproduce the image of the form.

18. The system for storing data of claim 17, wherein at least one the field type is chosen from a group consisting of text, signature, confidential, and image.

19. The system for storing data of claim 17, wherein the stored data is encrypted and unencrypted.

20. The database for storing data of claim 19, wherein the file merger is operative to detect when the stored data is encrypted and to generate a corresponding unencrypted version for the image of the form.
